(19) United States
(12) Patent Application Publication
(10) Pub. No.: US 2009/0070129 A1
(43) Pub. Date: Mar. 12, 2009

(54) Customer Discovery and Identification System and Method

(75) Inventors: Elad Inbar, Tel-Aviv (IL); Sephi Shapira, Ramot-HaShavim (IL)

Correspondence Address: Martin D Moynihan, P.O.Box 16446, Arlington, VA, 22215, US

(73) Assignee: Massive Impact International LImited 21/F., Quality Educational Tower, Kowloon (HK)

(21) Appl. No.: 11/918,645

(22) PCT Filed: Mar. 30, 2006
(86) PCT No.: PCT/IL2006/000402

§ 371 Date: Oct. 17, 2007

Related U.S. Application Data
(60) Provisional application No. 60/672,851, filed on Apr. 20, 2005.
(60) Provisional application No. 60/774,672, filed on Feb. 21, 2006.

(51) Int. Cl. G06Q 30/00

(52) U.S. Cl. 705/1

(57) ABSTRACT

A customer targeting tool for identifying and targeting potential customers on a network. The customer targeting tool comprises an discovery unit for analyzing customer data regarding customer reaction to previous promotion activity. The reactions being positive or negative and the analysis identify groupings from customers differentiated by the reactions. The customer targeting tool further comprises a targeting unit, associated with the discovery unit, and configured to target customers belonging to groups discovered from customers showing positive reactions.

### FIELD AND BACKGROUND OF THE INVENTION

The present invention relates to a promotion targeting tool, system and method, more particularly but not exclusively, to a promotion targeting tool, system and method based upon information regarding user interaction over communication networks.

As commonly known, most of today's marketing activities and promotions are targeted to a predefined group of potential customers. Targeted promotions, unlike random promotions, comprise a group of potential customers having common characteristics. The targeted potential customers are chosen according to an estimate made by the promoters and the marketers based on characteristics that correspond with the typical purchaser of the promoted product or service. By using targeted promotions, the cost which is associated with sending numerous promotion offers is reduced. The optimal mailing strategy depends on both the benefit obtained from a purchase and how the promotion offer affects the behavior of the potential customers.

By using targeted promotion, the promoters aim to increase the response rate to each promotion by centering the promotion efforts on a group that has common external and demographic characteristics. The promoters assume that external and demographic characteristics, such as gender, address and economic sector, reflect the customers' potential to purchase a promoted service or product. For example, a cellular content provider may chose a group of customer to promote a certain ringtone of a famous teenage rock star based upon the age of the group members. However, by electing potential customers to promote according to external and demographic characteristics, the promoters ignore potential customers having other demographic characteristics. Untargeted customers who do not correspond with the chosen group may want to purchase the product for numerous unexpected reasons. Moreover, since the potential customers are analyzed according to their external and demographic characteristics, no empiric evaluation of their reaction to previous promotions is calculated.

The progression of the communication network technologies enables promoter to accumulate more information about potential costumers. Network interactions are constantly performed for personal communication and commercial activity. One type of communication interaction is initiated by a specific user, and includes sending an SMS or an MMS, participating in a phone conversation, WEB surfing, etc. Another type of communication interaction is done without human intervention, such as an interaction with any computerized system via a communication network with an application server, including but not limited to billing systems, customer care systems, customer management systems, access to voicemail and other application servers, or roaming behavior of a cellular user.

Since each user performs numerous traceable network interactions over various networks, the amount of information that can be accumulated about each user is substantial.

The abundance of traceable network interactions allows the gatherer of the information to have the potential to elicit information about specific users. Such designated information can be used for personalized marketing which is a form of product differentiation. By analyzing information about the clients, the marketer or the advertiser tries to make a unique product offering for each customer.

However, the abundance of traceable network interactions also presents many hurdles for the gatherers since they have to analyze huge amounts of data regarding numerous recorded interactions associated with numerous users.

In order to, inter alia, enable the analysis of an abundance of recorded information, data mining techniques and methods have been developed over the last few years. Data mining is a technique by which hidden patterns may be found in a collection of data.

Contemporary data mining devices and modules do not just change the presentation of data, but actually discover previously unknown relationships among the data. Data mining is typically implemented as a software agent. Usually, the data mining software agent is added to a designated server in a database system and enables the analysis of the designated database records. In another data mining model, the software agent is implemented using designated hardware, which is connected to a computer network. In the aforementioned computer network model, the software agent is used to analyze network interactions.

Data mining techniques are an effective and progressive tool for advertising and marketing systems. Such systems usually have to analyze an enormous amount of user information. The user information comprises documented user network interactions and other user related information which is constantly gathered. The user related information comprises demographic information, average monthly bills, habits and other information regarding the user.

Using the data mining modules and other analytic tools, advertisers and marketers can provide a unique product and service for each customer according to his profile and usage history.

An example of a system that enables selected advertising or marketing content based on each user's profile and usage history is disclosed in U.S. Pat. No. 6,847,969, issued on Jan. 25, 2005. The patent discloses a personalized advertising system for providing personalized and integrated online services for communications and commercial transactions both in private and public spaces. The disclosure also provides advertisers with the opportunity to directly engage actual and potential user-consumers with selected advertising or marketing content based on each user's profile and usage history.

Another example for personalized advertising based upon data mining techniques is disclosed in U.S. Pat. No. 6,968,315, issued on Nov. 22, 2005. The patent relates to advertising over a communications network comprising a plurality of interactive client subscriber sites interconnected with an advertising information server site. The attributes of a plurality of customers are stored in the form of customer attribute vectors. The patent uses a marketing function which maps the customer attribute vectors to one or more role model attribute vectors. At the interface advertising information server site, interactive advertising displays are provided incorporating the one or more role models.

Notwithstanding the aforementioned, currently known targeting systems fail to support or inadequately support the analysis of sporadic and sparse data which has been gathered from various network interactions of probed users and do not combine information regarding the same user from various sources.

Moreover, the currently known targeting systems do not empirically analyze the behavior of the users. The known targeting systems analyze consumer related information which has been previously gathered by servers of different service providers. However, the known targeting systems do not probe or analyze the reactions of customers to their promotions. The analysis is usually passive, and does not integrate a learning mechanism that enables a more suitable promotion. The system does not gain knowledge of each promotion and, hence, does not generate a more productive and focused promotion for every subsequent promotion. The inability to utilize the advantages of empirically-gathered quantitative information of customers' reactions to promotions may lead to the distribution of subsequent promotions to the same targeted clientele. Currently, there is no targeting system that can examine sparsely existing information regarding user behavior patterns during long time periods and analyze the feedback to promotions during marketing processes that comprise more than one promotion iteration.

Hence, in order to improve the quality of the network interaction analysis, several challenges are to be met, including the analysis of user network interactions in a number of conscious or unconscious communication networks and combination of information which has been obtained from different sources. Another challenge is to utilize the information that can be extracted from different network interactions that each user conscious or unconscious performs with an applications and servers regarding the feedback the user has given to previous promotions. Another challenge is to utilize hyper sparse data from previous promotions to generate a new promotion.

That is to say, today actual purchases are carried out electronically, and computer networks have actual information about genuine purchases made. Yet current marketing systems are based on surveys, opinions, and extrapolations of the surveys. There is no attempt made to obtain and use the actual information about genuine purchases because of the way it is distributed over the network and because of the sheer volume of the information. Accordingly, there is an existing need, in the context of virtual environments, for a system that overcomes the shortcomings of conventional technologies, particularly as to targeting systems and personalized marketing and advertising. Thus, it would be highly advantageous to have a promotion targeting system and method devoid of the above limitations.

### SUMMARY OF THE INVENTION

According to one aspect of the present invention there is provided a customer targeting tool for identifying and targeting potential customers of a customer base. The customer targeting tool comprises a discovery unit for empirically analyzing customer data regarding customer reaction to previous promotion activity, the analysis to identify groupings from customers differentiated by the reactions, and a targeting unit, associated with the discovery unit, and configured to target customers belonging to groups discovered from customers showing correlated reactions.

Preferably, the analysis to identify groupings from customers is done according to at least one common characteristic of the customers.

Preferably, the targeting unit is adapted to be connected to a potential customer repository having a plurality of potential customer entries, each entry being associated with a potential customer; the customer targeting tool further comprising a classifier module for classifying the plurality of potential customer entries according to a set of classifying characteristics into a plurality of customer groups.

Preferably, the targeting unit is adapted to target potential customers of at least one of the groups, the targeted potential customers having at least one common characteristic with at least one of the groupings.

More preferably, the targeting tool is adapted to a sample group; wherein the sample group targeting tool is adapted to generate a promotion list according to sample group.

More preferably, the targeting unit comprises an output unit, the output unit being adapted to output a promotion list for a targeted promotion, the promotion list comprising the targeted potential customers.

Preferably, the plurality of potential customer entries having a unified pattern.

Preferably, the plurality of potential customer entries comprises at least one customer data regarding the related potential customer response to previous promotion.

Preferably, the plurality of potential customer entries comprises at least one customer data regarding network interaction of a related potential customer.

More preferably, the customer data comprises information originated from at least one member of the group consisting of: roaming systems, billing systems, customer care systems, provisioning systems, service delivery platforms, intelligent network and prepaid systems, data warehouse systems, customer management systems, mediation platforms, Partner management systems, Common service platforms, Mobile Switching Center (MSC), Interactive Voice Response (IVR) systems, Home Location Register (HLR) systems, Wireless Access Point (WAP) gateways, WEB servers systems, content billing servers, SMS systems, MMS systems, voicemail systems, and Customer Relationship Management (CRM) systems.

More preferably, the network interaction comprise at least one member of the group consisting of: sending a Short Messaging Service (SMS) message, switching between different WEB pages, switching between different television channels, connecting to a specific Wireless network, reacting to an IVR, accessing an e-mail account, and using a Wireless Application Protocol (WAP) pull action, making an online purchase, placing an online order, and making an online payment for a product.

Preferably, the plurality of potential customer entries comprises additional potential customer information, the additional potential customer information consisting of at least one of the following group members: a potential customer average monthly telephone bill, a potential customer age, a potential customer gender, a potential customer address, a potential customer occupation, a potential customer average telecommunication service monthly bill, and a potential customer average telecommunication service usage time.

Preferably, the network consists of at least one of the following group members: the Internet, the Ethernet, a cellular network, an interactive television network, and a Public Switched Telephone Network.

Preferably, the set of predetermined characteristics consists of at least one of following group members: behavioral patterns, content-interest preferences, and association with a particular demographic section.

Preferably, the customer targeting tool further comprises a response input wherein the response input operative for receiving promotion feedback from a plurality of potential customers responding to the targeted promotion.

More preferably, the response input is operative for receiving a list comprising the plurality of responding potential customers.

More preferably, the promotion feedback comprises information regarding the actual acceptance of the targeted promotion by the plurality of potential customers responding to the targeted promotion.

More preferably, the promotion list further comprises a plurality of estimated best promoting time records, each one of the estimated best promoting time records being associated with a corresponding potential customer in the list.

Preferably, the plurality of estimated best promoting time records is used for dividing the targeted promotion into different time periods.

Preferably, each of the plurality of potential customer entries comprises a feedback vector, the feedback vector being adapted for storing the related potential customer response to previous targeted promotions.

According to another aspect of the present invention there is a method for targeting a promotion over one or more communication networks. The method comprises the following steps: a) receiving information regarding a plurality of potential customers having a set of characteristics, b) receiving a sample group comprising a plurality of potential customers, c) generating a promotion list based on the sample group, d) receiving promotion feedback from a plurality of responding potential customers, e) identifying at least one common factor among the plurality of responding potential customers, and f) assessing the similarity between the set of characteristics of each one of the plurality of potential customers and the at least one common factor, using the assessment to generate a new promotion list.

Preferably, the method further comprises repeating steps (d)-(f) a plurality of times.

Preferably, step f) further comprises estimating the response rate to the promotion according to the new promotion list.

Preferably, step f) further comprises estimating a return on investment calculation regarding the promotion according to the new promotion list.

Preferably, step f) further comprises displaying the return on investment estimation, and allowing a system operator to adjust the new promotion list.

According to another aspect of the present invention there is a system for targeting a response based promotion over at least one communication network. The system comprises: a plurality of customer records, each customer record comprising at least one promotion response entry being adapted for storing a related customer data, the related customer data comprises promotion response of a related potential customer to a targeted promotion, a response input device for receiving the promotion responses from a plurality of responding customers, and a clustering module adapted for identifying at least one common factor of the plurality of responding customers, the clustering module adapted for matching the at least one common factor with a subset of the related customer data of the plurality of customer records, the clustering module generating a new promotion list based upon the matching.

Preferably, the clustering module further comprises a response pattern module, the response pattern module being adapted to identify the response pattern of each of the plurality of customer records, the identification done by analyzing the at least one promotion response entry.

Preferably, the clustering module is adapted for identifying at least one common factor of the plurality of customer records according to the response pattern of each of the plurality of customer records.

According to another aspect of the present invention there is a customer targeting system for identifying and targeting potential customers of a customer base. The customer targeting system comprises: a customer database having a plurality of customers entries, each of the plurality of customers entries comprising at least one feature subentry, a promotion response module for receiving a plurality of reactions of customers to promotion activities, the promotion response module being configured to store each one of the plurality of reactions in a respective feature subentry of a respective customer, and a targeting unit, associated with the customer database, and configured to target potential customers of the plurality of potential customers entries having at least one common feature, the at least one common feature being chosen according to respective the at least one feature subentry.

Unless otherwise defined, all technical and scientific terms used herein have the same meaning as commonly understood by one of ordinary skill in the art to which this invention belongs. The materials, methods, and examples provided herein are illustrative only and are not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the present invention could be described as being performed by a data processor, such as a computing communication network for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a tool for identifying and targeting potential customers, according to one embodiment of the present invention;

FIG. 2 is another schematic illustration of a tool for identifying and targeting potential customers, generating based thereupon a promotion list according to one embodiment of the present invention;

FIG. 3 is a schematic illustration of the promotion targeting system that comprises a tool for identifying and targeting potential customers, broadcasting servers, a group of potential customers, response collector servers and a list of responding customers;

FIG. 4 is a comparative graph of sectional classifications;

FIG. 5 is another schematic illustration of the tool for identifying and targeting potential customers further comprises a viewing module and input devices;

FIG. 6 is a flowchart diagram of a process for generating promotion lists based upon information which is related to potential customers and upon responses of customers to targeted promotions, according to a preferred embodiment of the present invention; and

FIG. 7 is another flowchart diagram of a process for generating promotion lists that further comprises the steps of estimating the return on investment and allowing the system operator to adjust the promotion list, according to a preferred embodiment of the present invention.

### DESCRIPTION OF THE PREFERRED EMBODIMENTS

The present embodiments comprise a system and a method for generating targeting promotion and for allowing the identification of new or inactive potential customers, in a process referred to herein as customer discovery.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

According to an embodiment of the present invention, there are disclosed a unique tool, system and method for targeted promotions using data mining models, natural selection and genetic algorithms to classify potential customers according to groups and for clustering potential customers on promotion lists. The present embodiments yield a list of potential customers targeted for promotion by combining data mining models, genetics algorithms, natural selection algorithms, pattern recognition algorithms, prediction algorithms and the like, based on any documented communication action or interaction a potential consumer may perform, inter alia: sending or receiving a Short Message Service (SMS), a Multimedia Messaging Service (MMS), an Enhanced Messaging Service (EMS), a phone call, or an IVR call. In addition, this may include switching between different WEB pages or television channels, connecting to a specific wireless or wired network, using a satellite or cable receiver, reacting to an Interactive Voice Response (IVR), accessing e-mail and text-based WebPages using a mobile phone, and any other form of recordable interaction that a potential consumer can do consciously or unconsciously with any system or communication network or application server as recorded over the online world. That is to say the present invention teaches targeting of marketing activity based on customer data as opposed to known marketing methods, known marketing assumptions and traditional surveys. Such an approach may be referred to as empirical marketing, and is herein called customer discovery.

Using the embodiments of the present invention, the operator of the tool may empirically predict the likelihood that a specific interaction with a customer will result in a specific action.

Therefore, the present invention creates a unique and innovative tool for operators, content providers, marketers, advertisers and other users. The potential operators of the preferred embodiments of the present invention can use the tool for identifying and targeting potential customers for promotion targeting that automatically targets potential customer groups according to actual preferences and real time reactions to related promotions.

The preferred embodiments of the present invention aim to give an efficient empirical tool that analyzes the behavior of potential customers during an unspecified period.

In particular, preferred embodiments of the present invention enable the discovery of potential customers. New and existing customers are identified as potential customers for offerings of products and services. Preferably, the tool for identifying and targeting potential customers identifies which group of customers should be chosen for specific promotions in order to achieve the highest return on investment (ROI), by calculating the return time factor.

In addition, other preferred embodiments of the present invention aim to empirically examine the characteristics of customers who have responded to different promotions and to generate a new targeted promotion based upon the common characteristics of those responding customers.

Using the preferred embodiment of the present invention, the potential consumers are offered promotions that match their specific needs and interests. The tool for identifying and targeting potential customers can address aspects in both the personal life and professional life of potential customers.

The tool has the ability to collect customer related information and to extract habits and fields-of-interest data about different potential customers therefrom. In addition, the tool has the ability to collect and analyze information about the reactions of potential consumers to products and services that the potential consumers have taken an interest in during previous promotions.

Information about the preferences of potential customers can be extracted from various network interactions. The network interactions which can be monitored originate from various sources such as, for example, cellular service servers, ISP service servers, PSTN central server, etc. The gathered customer related information is used to generate an empirical decision regarding the suitability of the customer to a certain promotion. The physical meaning which is represented in the gathered customer related information is not analyzed. The tool according to the present embodiments does not differentiate between different customer related information by preferring one piece of information over the other. For example, customer related information regarding the age of the client is equally valued as customer related information regarding the customer SMS communication habits.

Unlike previous promotion tools, the physical meaning which is represented by the customer related information is not analyzed or valued during the promotion generation process.

In the foregoing description there are a number of terms which should be understood in the light of the following explanations:

A network traffic event or network interaction may be understood as any documented communication action or interaction a potential consumer may perform, inter alia: sending or receiving a Short Message Service (SMS), a Multimedia Messaging Service (MMS), an Enhanced Messaging Service (EMS), a phone call, or an IVR call. In addition, this may include switching between different WEB pages or television channels, connecting to a specific wireless or wired network, using a satellite or cable receiver, reacting to an Interactive Voice Response (IVR), accessing e-mail and text-based Web pages using a mobile phone, and any other form of recordable interaction that a potential consumer can do consciously or unconsciously with any system or communication network or application server.

Customer data and Information about potential customers may be understood as information which originates from one of the following system: roaming systems, billing systems, customer care systems, provisioning systems, service delivery platforms, intelligent network and prepaid systems, data warehouse systems, customer management systems, mediation platforms, Partner management systems, Common service platforms, Mobile Switching Center (MSC), IVR and HLR systems, Wireless Access Point (WAP) gateways, WEB portals, content billing servers, SMS and MMS server systems, voicemail servers. The information about the potential customer may be understood as information about the potential customer roaming behavior, billing information or price plan the potential customer uses, other Customer Relationship Management (CRM) information such as addresses, demographic section, gender and age, and any other form of information about the potential consumer.

A network traffic event or network interaction may also be understood as any communication interaction between a personal computer or mobile phone and one of the following systems: a billing system, a customer care system, a provisioning system, a service delivery communication network, a prepaying system, a data warehouse system, a customer management system, a mediation communication network, a Partner management system, a common service communication network, a Mobile Switch Center (MSC), a roaming system, a HLR or an IVR system, a WAP gateway, a WEB portal, a Content billing server and a voicemail server.

Mobile network interactions may be done for example using one of the following protocols and applications: Wireless Application Protocol (WAP), JAVA, Binary Runtime Environment for Wireless (BREW), 3rd Generation Partnership Project (3GPP) i-mode or other protocols, a technology which is used to enable the user to have Web access, technology which is used to enable sending and receiving SMS, MMS, known protocols of downloading or uploading content, known protocols of subscription to a service or to a product, known protocols of location based information, known protocols of performing IVR calls or any other type of interaction a user can perform with a mobile network.

The traffic events or network interactions comprise descriptive information about a user. Such descriptive information may represent a roaming behavior of the user, the price plans to which the user is registered and Customer Relationship Management (CRM) based information such as customer address, customer demographic sector, customer gender and age, customer profession, etc.

Promotions may be understood as any means for providing a number of potential customers with one or more of the following messages: a SMS message, a WAP push message, a WAP page, a MMS message, a banner, a fax message, an interactive television message, an email message, a web page, an IVR recording, a phone call, a voicemail recording, an advertisement of any kind, a churn management promotion, a price plan promotion, a printed message on the monthly bill, and any other form of message delivered to a user.

Each one of the aforementioned promotion messages may comprise marketing content, advertising, a registration invitation or any other form of content that should be delivered to customers by any advertiser or marketer who wishes to address potential customers with a targeted promotion.

Potential customers, customers, users or user identifiers may be understood as: mobile users obtained by Mobile Station Integrated Services Digital Networks (MSISDN), individual users obtained by usernames and password combinations, unique identifier identities or any other form of authentication to uniquely identify the users.

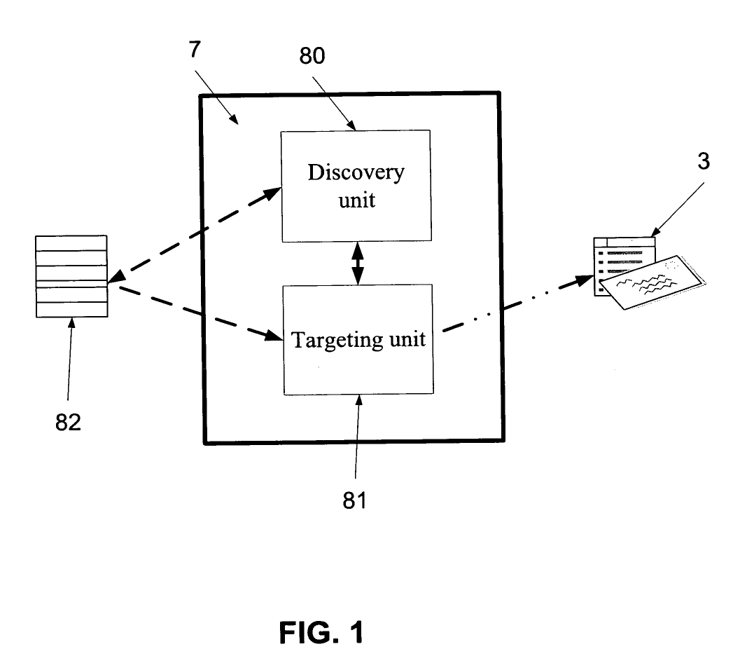

Reference is now made to FIG. 1 which depicts an exemplary targeting tool for identifying and targeting potential customers according to one embodiment of the present invention. The customer targeting tool 7 includes a discovery unit 80, which is associated with a targeting unit 81. The targeting unit 81 outputs a promotion list 3 that comprises a group of potential customers from a certain database of customer data 82. The discovery unit 80 is configured to analyze customer data 82 regarding, inter alia reactions of customers to promotion activities and other information which is related to the potential customers, preferably as related network interactions. Each analyzed reaction, for example, preferably reflects a certain customer decision regarding the purchasing of a certain product or a service. The reaction may be positive, negative or any other reaction that reflects the potential customer decision regarding the related promotion activity. Such data is customer data of actual purchasing, and is analyzed by the discovery unit 80 in order to identify groupings of customers. The groupings are differentiated by the customers' reactions and additional information which has been gathered about the customers.

In addition, the discovery unit 80 is used to identify common characteristics of customers who have respond to a previous promotion in a common manner. Based upon the identified common characteristics, the discovery unit 80 generates a customer profile, which is transferred to the targeting unit 81. Targeting unit 81 scans the customer data 82 to assess the similarity of each documented potential customer to the customer profile. Based upon the assessment the targeting unit 81 generates a promotion list 3 that comprises a list of potential customers of the customer data 82 with a correlated assessment.

For example the discovery unit 80 may be used to analyze the reaction of a batch of customers to a dairy product promotion. The discovery unit 80 differentiates between customers who have responded to the promotion positively and customers who have responded to the promotion negatively or have not responded to the promotion at all. That is to say, the unit differentiates between customers who as a response to the promotion bought the dairy product and customers who as a response to the promotion did not buy the dairy product.

The group of customers who have responded positively to the promotion may be analyzed by the discovery unit 80 to target customers for new promotions. The targeting unit 81 is configured to target customers belonging to groups discovered by the discovery unit 80.

As described above the discovery unit 80 generates a customer profile which is used by the targeting unit 81 to identify a larger group of potential customers who have been assessed as sharing common characteristics with the customer profile.

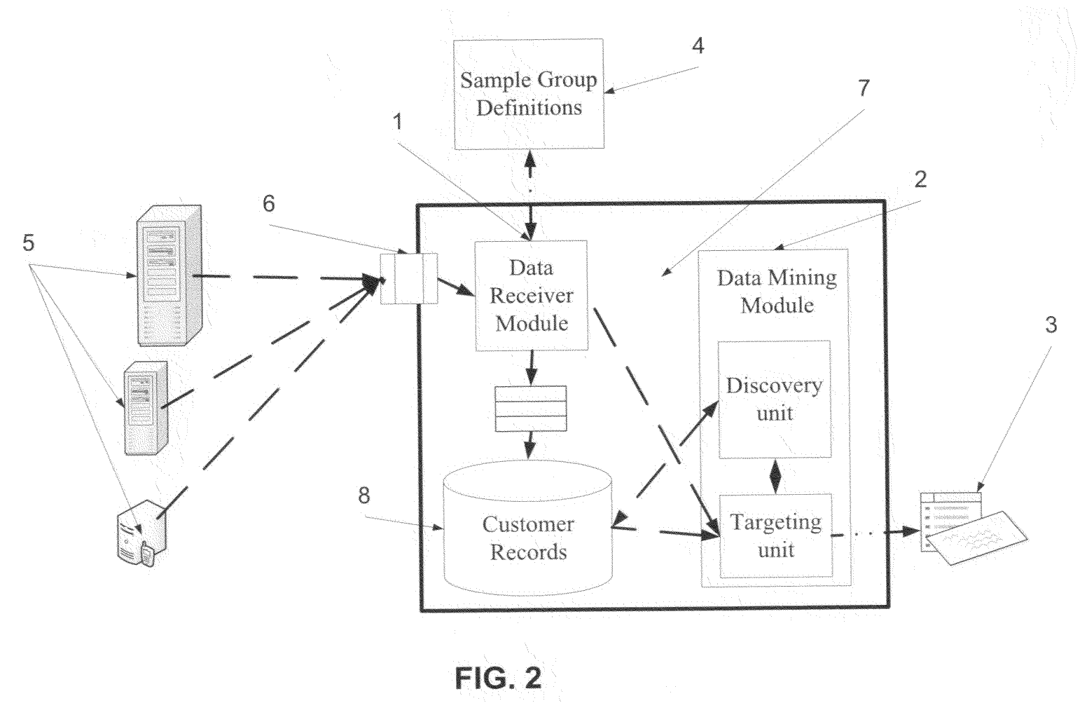

Reference is now made to FIG. 2 which shows another exemplary embodiment of the present invention. The discovery unit 80, the targeting unit 81, the customer data 82 and the targeted customers 3 are similar to those shown in FIG. 1 above. However, FIG. 2 further comprises a data receiver module 1 and a data source(s) 5. In addition, in FIG. 2 the discovery unit 80 and the targeting unit 81 comprise a data mining module 2. The data mining model is used by the customer targeting tool 7 to analyze customer data 82 and to output a list of targeted customers 3 which is used as a promotion list.

The received interaction data 6 comprises records and entries. Each record or entry comprises information regarding a certain network interaction and a unique user identifier. The unique user identifiers imply which user is involved in a particular network interaction.
As described above, the discovery unit 80 generates a customer profile which is used as a reference for the targeting unit that generates based upon a promotion list 3. The customer profile is generated according to previous promotion reactions and network interactions. The initial promotion list is used to generate a promotion whose reactions are the basis to generating a customer profile for the succeeding promotion.

Hence, the data receiver module 1 receives a sample group 4. The sample group 4 comprises a make-up of the first promotion list which is generated by the tool for identifying and targeting potential customers, as described below.

The data receiver module 1 translates each received network interaction datum that comprised the unparsed customer data into user interaction entries which are parsed according to a predetermined unified pattern, comprising a parsed batch of customer data 82.

The data mining module 2 stores each potential customer network interaction that has been received from the data receiver module 1 in a designated entry. Each entry is associated with a corresponding customer record. Since the customer records 8 are uniformly parsed, their analysis can be done in a straightforward manner using the data mining module 2, as described below. Preferably, the customer records 8 are stored in a designated repository.

Network interactions may be stored as entries. Each entry comprises subentries, such as interaction occurrence date, interaction occurrence time, interaction type, estimated or known interaction cost, etc.

Since, as mentioned above, the data receiver module 1 may be connected to more than one data source 5, the network interactions which are received from the data sources represent interactions from different telecommunication systems.

Preferably, additional related information regarding the potential customer can be stored as additional subentries. For example, additional subentries may comprise information regarding the potential customer's average monthly telephone bill, the potential customer's age, the potential customer's gender, the potential customer's address, the potential customer's occupation, the potential customer's average monthly cellular telephone bill and average usage time, the potential customer's average monthly regular telephone bill and average usage time, the potential customer's average monthly ISP bill and average usage time, etc.

As mentioned above, the targeting unit of the data mining module 2 is configured to target customers. Based upon those targeted customers the data mining module 2 generates a targeted promotion list 3 which is used as an addressee list for the targeted promotion of a certain service or product. The generated targeted promotion list 3 comprises contact information about the potential customers in the list. Preferably, the contact information comprises one or more of the following contact information: a private telephone number, a mobile telephone number, an electronic mail address, a home address, a telephone number at a business location, a fax number, an IP address, a personal ID number, a VoIP user name, etc.

Preferably, each entry of the targeted promotion list 3 further comprises information regarding the best time of day that the potential customers may be contacted. Accordingly, the targeted promotion list 3 can be used to generate promotions at different time periods during the day. Such a targeted promotion may result in an improved response rate.

As depicted in FIG. 2, the targeting unit of the data mining module 2 is configured to receive the sample group definitions 4 via the data receiver module 1. The customer targeting tool 7 is designed for analyzing responses of potential customers to promotions. Based on the analysis, the customer targeting tool 7 generates a new promotion list. However, when the tool for identifying and targeting potential customers has just been initiated, there are no responses that the customer targeting tool 7 can analyze in order to output an initial promotion list.

In order to enable the generation of the initial targeted promotion list 3, sample group 4 is provided to the customer targeting tool 7.

The sample group 4 comprises customers who are documented in the customer records 8. The sample group 4 is used to generate a targeted promotion list 3 that comprises the listed potential customers. After all the matched potential customers have been added to the targeted promotion list, the data mining module 2 outputs the targeted promotion list 3.

Preferably, the make-up of the initial promotion list represents the variance of all the potential customers who are documented in the stored customer records 8. For example, if the customer records 8 comprise 1000 records, where 800 of them are related to women and 200 of them are related to men, the sample group is used to generate an initial promotion list that comprises women and men in a ratio of 8:2. The initial promotion list maintains the same gender variance that exists in the customer records 8.

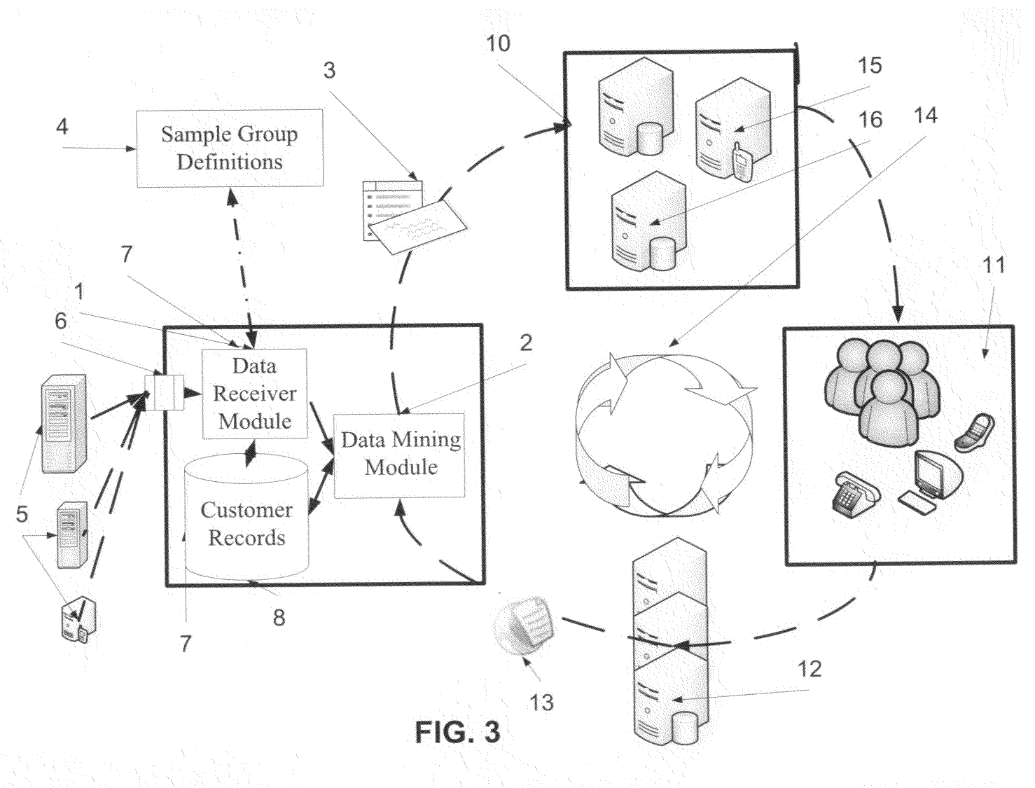

Reference is now made to FIG. 3 which shows another exemplary embodiment of the present invention. The data receiver module 1, the data mining module 2, the promotion list 3 and the data source(s) 5 are similar to those shown in FIG. 2 above. However, FIG. 3 further comprises broadcasting servers 10, a group of potential customers 11, response collector servers 12 and a list of responding customers 13.

One advantage of the present invention is its ability to learn from the responses and network interactions of the potential customers that have been targeted in the past. The learning procedure enables the customer targeting tool 7 to perform an empirical evaluation of the characteristics of the responding customers.

In one embodiment of the present invention, the customer targeting tool 7 is proactively used to independently initiate a promotion, and to collect the responses to the promotion from customers which responded to the promotion. As further described below, the customer targeting tool 7 analyzes the characteristics of customers who responded to the promotion and identify one or more common factors among their characteristics. Then, the common factors are matched with the customer records 8 that comprise subentries of the characteristics of potential customers. Based on this match, a group of potential customers is chosen to be promoted on the next promotion of the customer targeting tool 7. Such a proactive tool differs from the passive promotion tools that use existing information for generating a new promotion. Unlike the passive promotion tools, the customer targeting tool 7 independently generates a promotional event and actively gathers responses to the promotional event. Thus, unlike passive promotion tools the customer targeting tool 7 does not relay only existing information but generates events that provide it with information that can be empirically analyzed.

As depicted in FIG. 3 the targeted promotion list 3 is transferred to one or more broadcasting servers 10 that disseminate, via telecommunications media, the promotion according to the targeted promotion list 3. As described above, the listed potential customers receive the promotional content via various telecommunications media.

Preferably, the one or more broadcasting servers 10 are connected to a cellular communication network. Such broadcasting servers 10 can be used for transmitting promotional content directly to the mobile phones of the potential customers who are listed in the targeted promotion list 3.

Broadcasting cellular servers 15 may be used to send a message that comprises promotional content using one or more of the following messaging protocols: an SMS, an MMS, an EMS, a WAP push message a printed message on the monthly bill, or any other messaging protocol or mechanism that can be used to transmit specific content to mobile phones.

More preferably, one or more of the broadcasting servers 16 is connected to a computer network. Such broadcasting servers 10 can be used for transmitting the promotional content directly to the personal computers or to the PDA of potential customers who are listed in the targeted promotion list 3. The connection may be via either land communication or wireless communication.

Broadcasting network servers 16 may be used to send a message that comprises promotional content in one or more of the following messaging protocols: electronic mail, Chat messages, VoIP messages, Pop-Up WebPages, a voicemail message, an automatic IVR call, a printed message on the monthly bill or any other protocol that can be used to transmit specific content to personal computers.

More preferably, the one or more broadcasting servers 10 are connected to a Public Switched Telephone Network. Such broadcasting servers 10 can be used for transmitting promotional content directly to the telephone devices of potential customers who are listed in the targeted promotion list 3.

Broadcasting servers 16 may be used to send a message that comprises the promotional content as an IVR call or as a facsimile message. Subsequent to the sending of the promotional content, the potential customers may act in response to the promotion.

For example, in one preferred embodiment of the present invention, the broadcasting servers comprise a server which is connected to a cellular communication network. In a preferred embodiment of the invention, the listed potential customers receive one or more messages on their mobile phones that offer them a certain product or service. The potential customers may react to the promotion either by sending a reply message to the sender or to a number which has being included in the promotion message.

As depicted in FIG. 3, a reply message or any other response is sent to one of the response collector servers 12. The response collector servers 12 gather the responses of the customers and forward the responses to the customer targeting tool 7.

Preferably, the response collector servers 12 forward a response list 13 that comprises all the responses which have been accepted during a certain period. The response list 13 is transferred to the customer targeting tool 7. Preferably, the response collector servers 12 parse the responses according to a predetermined unified pattern before forwarding them. The output response list 13 is transferred directly to the data mining module 2 of the customer targeting tool 7. The customer targeting tool 7 stores the responses to the targeted promotion sent to customers on the targeted promotion list 3 in a designated repository. Each response is associated with a customer record which is designated to store information regarding the corresponding responding customer. Preferably, the responses comprise a record that defines the promotion.

As described above, the promotion lists are sent to a list of designated potential customers. The reactions to the promotions are documented and used to generate a new, more focused promotion lists. However, not all the designated potential customers have actually received the promotion. The potential customer record may not reflect the actual content information of the related potential customer. For example, if a designated potential customer changes his email address or mobile phone number, an SMS or email based targeted promotion fails to target him. It is important to differentiate between potential customers who have been targeted and received the promotion, to those who have not received the promotion in order to correctly estimate the potential customers' reactions to the targeted promotion.

Preferably, the response collector servers 12 further receive information regarding the promotion activities which have been actually delivered to the designated potential customers. Accordingly, the customers' records are updated to document the reactions of the customers according to the actual delivery status of the promotion offers.

Preferably, each record of the customer records 8 is associated with one or more response vectors. Each response vector stores the responses of the related customers to different targeted promotions.

As depicted in FIG. 3, the procedure of performing a promotion according to a targeted promotion list 3 and gathering the responses to that promotion is cyclical, as shown by arrows 14.

The customer targeting tool 7 generates a targeted promotion list 3, which is transferred to broadcasting servers 10. The broadcasting servers 10 are used to generate a targeted promotion according to the targeted promotion list 3 and to send messages to listed potential customers 11. The responses of the listed potential customers 11 to the targeted promotion are recorded in response collector servers 12 and are sent back to the customer targeting tool 7.

Moreover, since the process is cyclical, targeted promotion lists may be sent only to potential customers who are not listed in the previous targeted promotion list 3. Preferably, the targeting unit 81 of the data mining module 2 verifies that the potential customers in the targeted promotion list 3 do not already subscribe to the promoted service.

Since the targeted promotion may be performed several times, a large number of responses to different targeted promotions may be documented in the customer records 8.

The responses of the listed potential customers 11 comprise information that can be efficiently used by the customer targeting tool 7 during the next promotion. Preferably, the responses of each promotion are updated in a designated table. Each row of the table represents a particular potential customer. Each column of the table represents a particular promotion. Every new targeted promotion adds a new column to the table that represents the responses to that specific targeted promotion.

As described above, the customer targeting tool 7 receives and stores information regarding different network interactions of potential customers. The information is stored in customer records 8 which are placed in a designated repository.

Preferably, the information regarding the potential customer responses to promotions is added to the already stored information regarding various network interactions the potential customer has preformed. Accordingly, the customer records 8 comprise a substantial amount of information regarding each potential customer. The accumulated information about the potential customers can be used to classify the potential customers.

In one preferred embodiment of the present invention the data mining module 2 comprises a behavioral analysis module. The behavioral analysis module comprises a set of functions. Each function defines a different possible behavioral pattern.

By matching the terms of each function with the subentries of a certain customer record, the behavioral analysis module determines whether the certain customer record fulfills a behavioral pattern which is defined by the function. Accordingly, if the behavioral pattern has been successfully matched with the customer record, the customer record is associated with a group of potential customers which comprises the related behavioral pattern.

However, if the behavioral pattern has not been successfully matched with a customer record, then the customer record is either automatically associated with another group or is marked as not matching the behavioral pattern of the function.

Preferably, all the customer records 8 are matched with different functions that represent different related behavioral patterns to create groups of potential customers. Each customer record may be classified according to several behavioral pattern groups.

In another preferred embodiment of the present invention, the customer records 8 may be classified according to sectional classification. As described above, each customer record may comprise subentries that contain demographic information regarding the potential customers. The demographic information, when combined with information regarding the potential customer network interactions or with the potential customer responses to promotions, may be used to classify the customer records.

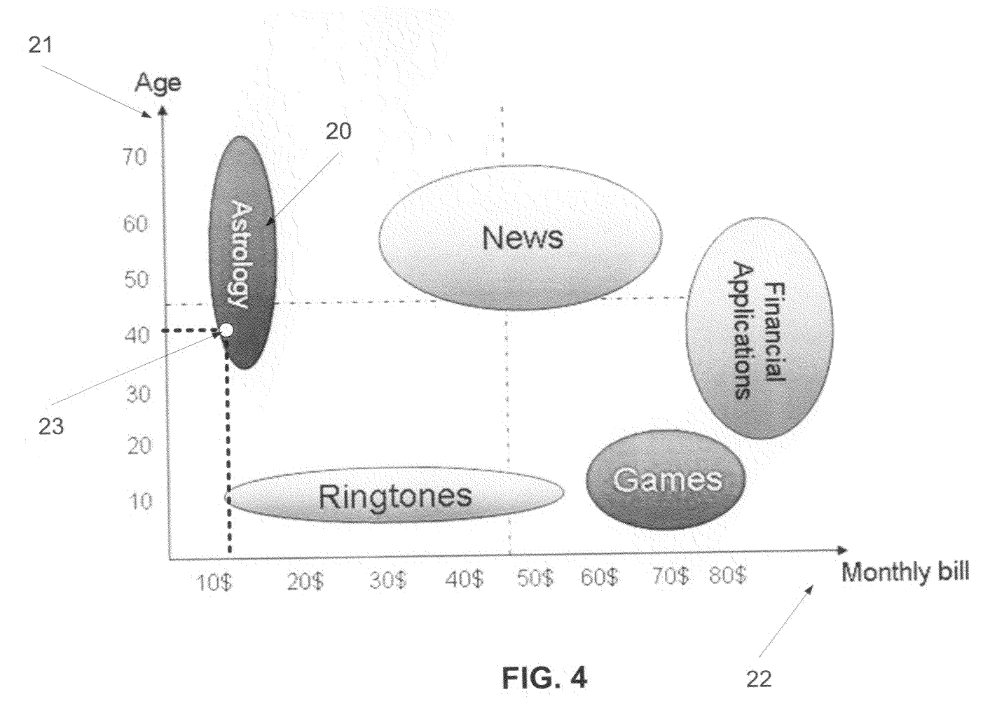

Reference is now made to FIG. 4 which depicts a comparative graph of classification according to sectional classifications. The graph depicts groups of potential customers which are divided according to purchased cellular services. The X axis 22 of the graph represents the possible amount of the monthly cellular bill of the potential customers. The Y axis 21 of the graph represents the possible ages of the potential customers.

As depicted in FIG. 4, customer records may be classified according to the combination of consumption habits, amount of the monthly bill and demographic information such as age. Each of the ellipses in the graph represents a different group of potential customers that purchased a specific cellular service. Accordingly, each ellipse represents the boundaries in which the characteristics of group members which are represented in the graph are found. That is to say that the boundaries of a certain ellipse define an area that comprises a group of potential customers who, according to their characteristics, could have been plotted as a point in that certain ellipse.

For example, the ellipse that is entitled Astrology 20 represents a specific group of potential customers, between the ages of 35 and 75, that have an average monthly cellular phone bill of $10 to 20$ and purchase a service of cellular content delivery which is related to astrology. All the members of the specific group of potential customers could have been plotted as points within the boundaries of the Astrology ellipse. For example, a 40 years old member group that has an average monthly cellular phone bill of $12 dollars and has purchased one or more services of cellular content delivery which is related to astrology is represented as a point 23 on the graph. The point 23 is plotted within the boundaries of the ellipse that is entitled Astrology 20.

Preferably, the ellipses are created to include a cluster of potential customers which are gathered one next to the other according to the related graph. Accordingly each ellipse defines a group of potential customers with a common sectional classification. Such a sectional classification may be used to define a targeted promotion list according to a field of interest, consumption habits, and willingness to pay. Preferably, the sectional classification further combines behavioral characters. Though the identified consumers may not exactly fit the classic consumer profile which is based upon known demographic criteria, their behavioral pattern suggests that they have the potential to purchase the service or the product of the promotion. Based upon the information which is stored in the customer records 8, the data mining module 2 may analyze the behavioral section of related potential customers. For example, simple analysis can be made to identify a group of potential customers that use their cellular phones mostly late at night. Such a behavioral pattern, in combination with demographic information such as age and address can be used to promote a late night restaurant located in the area of the identified potential customers.

In another example, documented roaming activity can also be used for designating potential customers as a group that comprises potential customers that tend to travel.

Using the behavioral patterns, such as sectional classification criteria, the operators of the customer targeting tool 7 are able to define specific groups of potential consumers which cannot be easily defined by demographic terms.

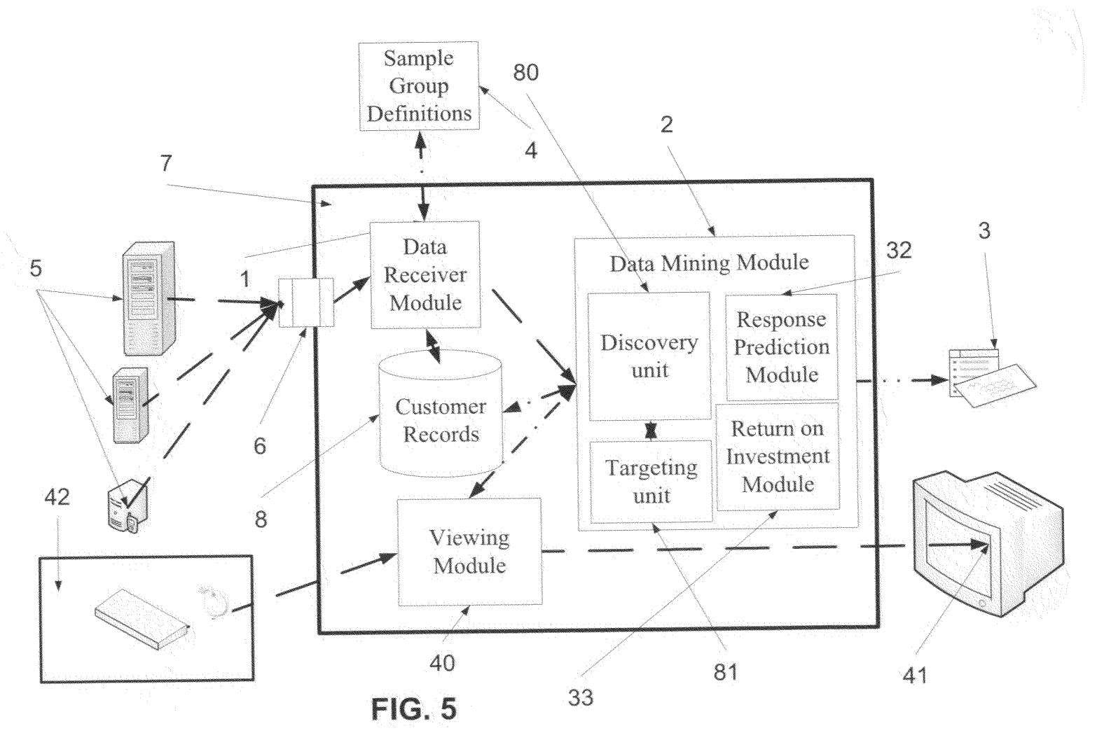

Reference is now made to FIG. 5 which shows another exemplary embodiment of the present invention. The data receiver module 1, the data mining module 2, the promotion list 3 and the data sources 5 are similar to those shown in FIG. 2 above. However, FIG. 5 further describes a viewing module 40, and a display device 41, input devices 42. In addition, the data mining module 2 further comprises a response prediction module 32 and a return on investment module (ROI) 33.

As described above, the data mining module 2 classifies customer records, inter alia, according to various sectional classifications. A mixture of behavioral patterns, demographic characteristics and responses to promotions can be used to create a targeted promotion list 3.

However, the targeted promotion list 3 should be generated in a manner that maximizes the potential of the promotion. Accordingly, the promotion list should be comprised of a group of potential customers from the customer records 8 who are most likely to respond to the promotion.

As depicted in FIG. 5, the data mining module 2 preferably comprises a response prediction module 32. The response prediction module 32 is used to predict the response rate of different groups of potential customers. Based upon customer records 8, the response prediction module 32 estimates the response rate of potential customers that belong to a certain group.

Preferably, in order to estimate the response rate of different potential customers that belong to different groups, the response prediction module 32 separately ranks each potential customer who is documented in the customer records 8. The potential customer rank represents the estimation of the response prediction module 32 regarding the response probability of the potential customer. The higher the rank, the higher is the estimated response probability of the potential customer. The ranking of each potential customer is done by analyzing the subentries of the respective customer record.

The estimation of the response probability of each potential customer is measured with regard to the potential customer group.

Preferably, the response prediction module 32 tags each group with a reference value that represents the optimal customer profile that the group may contain.

In addition, response prediction module 32 tags each potential customer with an estimated response value. The estimated response value of each potential customer is determined according to the subentries of the respective customer record.

During the ranking process of each potential customer, the response prediction module 32 evaluates the differential distance between the reference value and the estimated response value of the potential customer. The shorter the differential distance between the potential customer and the reference value, the higher is the rank.

Preferably, the response prediction module 32 stores the rank of each potential customer. The stored rank of each potential customer is associated with a respective customer record.

Preferably, a Naïve Bayes classifier model and Decision Trees can be used to estimate the potential customer's rank. The Naïve Bayes algorithm and Decision Trees are generally well known in the art and are, therefore, not described here in greater detail.

After evaluating the ranking of each potential customer, the response prediction module 32 determines the average potential customer ranking of each group. Based upon the ranking of the groups, the response prediction module 32 determines which group has the highest estimated response rate. The estimation is used to generate a promotion list 3 that comprises potential customers that belong to the group with the highest estimated response rate.

In one preferred embodiment of the present invention the data mining module 2 is further connected to a viewing module 40 and to an input device 42. The viewing module 40 is connected to a display device 41 that receives the display instructions from the viewing module 40 and thus allows the display of the outcome of the data mining module's calculations.

Preferably, the response prediction module 32 of the data mining module 2 sends signals to display device 41 to display the estimated response rate of each group.

Preferably, the data mining module 2 enables the tool operator 7 to adjust the promotion list 3. For example, the tool operator 7 can minimize the promotion list 3 to include only potential customers with a high estimated response rate of potential consumers. The displayed estimation implies which group has the highest estimated response rate and suggests the system operator a set of different make-ups of an optional promotion lists having different estimated response rates. The system operator may choose to target only a limited group to achieve a high estimated response rate but lower overall response, or alternatively a larger group having lower estimated response rate but which comprises additional potential customers from other groups.

For example, the displayed estimation may comprise various suggestions to give between 50% and 90% estimated response rates. The suggestions have different sizes and costs. The promoter can choose one of the suggestions, according to his preferences, as described in Provisional U.S. Patent Application No. 60/774,672, filed on Feb. 21, 2006.
The tool operator can use input device 42 to either confirm or decline the aforementioned suggestion.

Preferably, an input device 42 can be used to input instructions to the data mining module 2. A common mouse device and a common desktop keyboard can be used as input devices, both connected to a computing unit (not shown) which controls the display device 41 and allows tool operators to input instructions and to make selections.

One significant consideration in formulating a targeted promotion list is the return on investment (ROI) factor and profitability. The distribution of the promotional content to potential customers according to the targeted promotion list 3 demands an investment from the promoter. For example, sending a large quantity of messages over cellular telecommunication networks to numerous potential customers may result in high airtime expenses to the promoter.

The ROI module 33 may be used to estimate the desirability of a targeted promotion according to different clusters of potential customers. As described above, the data mining module 2 may generate various clusters of potential customers according to different sectional classifications.

The ROI module 33 may be used to gauge the desirability of a promotion which may be held according to the aforementioned cluster of potential customers. Preferably, the ROI module 33 calculates different factors during the desirability estimation. The ROI module 33 may be used to estimate a combination of two or more of the following factors: the cost per message, the number of potential customers in each possible promotion list, the estimated response rate, the estimated response time, the cost of storing information regarding the potential customers in the memory of the a designated repository of the tool for identifying and targeting potential customers, revenue sharing agreements with third parties, or any other estimation regarding the chances of the promotion to achieve specific business objectives in regard to a specific potential customer. Preferably, the promotion list with the highest return on investment is chosen.

In one preferred embodiment of the present invention the ROI module 33 outputs signals that represent the return on investment. In a preferred embodiment of the tool, a tool operator may watch the ROI factor, which is displayed on the display device 41, before approving the promotion. Preferably, the ROI module 33 estimates the ROI of each potential customer according to different business objectives and allows the tool operator to adjust the promotion list accordingly. Hence, the tool operator may adjust the list according to business objectives that match the business objectives of targeted promotions.

In a preferred embodiment of the present invention, the customer targeting tool 7 further comprises a response pattern learning module (not shown). As described above with reference to FIG. 3, the customer targeting tool 7 receives responses to targeted promotions from one or more response collector servers 12. The responses are stored and documented in association with customer records 8. As an apparatus that is constantly storing and analyzing the responses of various customers to targeted promotions, the customer targeting tool 7 is a learning mechanism. The customer targeting tool 7 constantly performs an empirical sampling of the responses of the customers who are documented in the customer records 8. The customer targeting tool 7 may classify the customer records 8 according to profiles of customers who have responded to the promotion. Accordingly, the customer targeting tool 7 performs a statistical analysis that relies on outcomes of actual promotions and not just on assumptions or physiological analyses of behavioral patterns.

The response pattern learning module is configured to analyze the responses which are documented in the customer records 8. As mentioned above, each customer record may be associated with one or more response vectors. Each response vector stores the responses of the related potential customer to a large number of different promotions.

In use, the response pattern learning module accesses customer records and analyzes the stored information which relates to responses to promotions. The pattern learning module identifies one or more common factors among all the customers who have responded to a certain promotion. Preferably, natural selection algorithms and genetic algorithms are used to identify the common factors.

After one or more common factors have been identified, the response prediction module 32 of the data mining module 2 is activated. The response prediction module is used to determine which of the groups has the highest estimated response rate, in the light of common factors of the responding customer group.

Preferably, the response prediction module 32 identifies the differential difference between the different groups and the responding customer group. After matching one or more of the groups with the responding customer group, the response pattern learning module generates a targeted promotion list 3. The targeted promotion list is comprised of potential customers of one or more groups with the highest estimated response rate.

It should be noted that, in order to efficiently estimate the common factor of the responding customers, the group must comprise a certain minimum number of responding customers. However, the number of potential customers who have responded to the promotion may be limited since some promotions may have only a few respondents.

In order to overcome the problem of a lack of respondents, preferably an additional set of randomly created responses is generated by the response pattern learning module. The additional set of randomly created responses is added to the responding customer group. The addition of the additional set increases the number of members of the responding customer group to at least the minimal required number of responding customers. Accordingly, the response prediction module is able to calculate the common factors of the responding customers.

Preferably, as noted above, the data mining module 2 comprises a pattern recognition module (not shown). The pattern recognition module is used as a link between the data mining module 2 and the response pattern learning module (not shown).

As depicted above and shown in FIG. 3, the procedure of performing a promotion according to a targeted promotion list 3 and gathering the responses to that promotion is cyclical, as indicated by arrows 14. The preferred embodiment that discloses the cyclical procedure enables the analysis of responses to promotions in order to generate a new and more focused targeted promotion list 3.

The pattern recognition module gathers the responses the response pattern learning module collects and stores them in association with related customer records 8. Based upon the customer records 8, the customer targeting tool 7 identifies the variation between the different groups of customers who have responded to pervious promotions. Preferably, a Naïve Bayes classifier model and Decision Trees can be used to estimate the variation.

Preferably, the variation is measured by a dynamic table. Each row of the table represents a particular potential customer. Each column of the table represents a particular promotion or another potential preference of the potential customer. In one preferred embodiment of the present invention, the table comprises columns that represent the initial information which has been gathered concerning potential customers, as described above, and columns that represent the responses to promotions. In use, for every new targeted promotion, the pattern recognition module adds a new column to the table that represents the responses to that specific targeted promotion. A summation of the values in each row may be used to produce a customer grade. For example, one column may represent a behavioral pattern of the potential customers or their association with a certain demographic sectional classification. During every targeted promotion, the grade of several potential customers is updated. Hence, summing each row after every promotion may produce a new and more current potential customer grade.

Implementing such a table enables the customer targeting tool 7 to have the ability to integrate the information which has been gathered during previous promotions in the process of generating the subsequent new targeted promotion list 3.

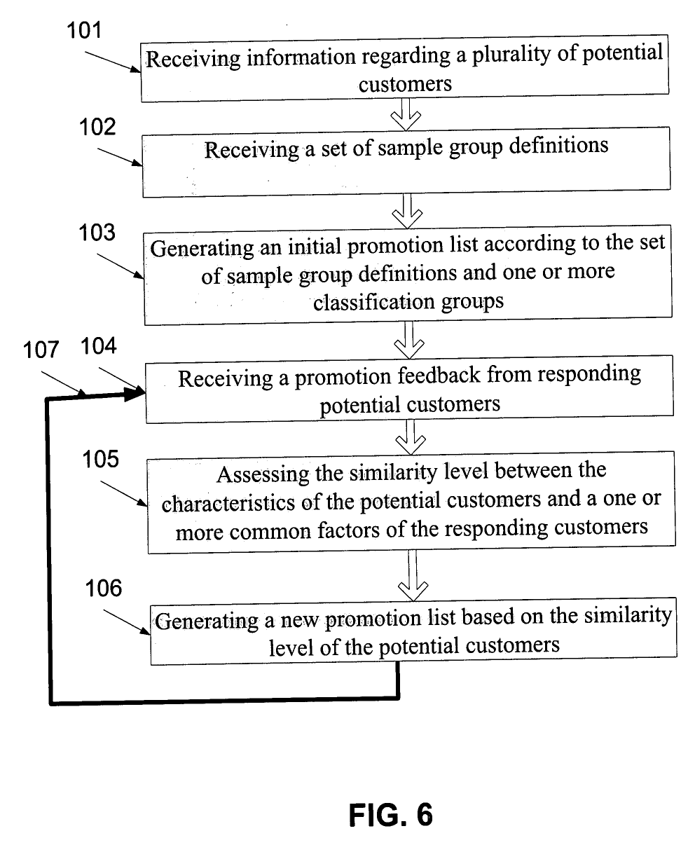

Reference is now made to FIG. 6 which is a flowchart of an exemplary method according to a preferred embodiment of the present invention for facilitating the generation of promotion lists based upon information related to potential customers and upon responses of customers to targeted promotions.

As shown in step 101, the targeted promotion system receives information regarding a plurality of potential customers. As described above, the information originates from various sources. The information reflects the demographic classification, behavioral patterns and other information that can be used for determining the sectional classification of the documented potential customers. In step 102, the targeted promotion system receives a sample group which is used to generate an initial promotion list, as shown in 103. The initial promotion list is used to initiate a cyclic promotion process, as described above.

During the following step, as shown in 104, the learning process of the system is initiated. The targeted promotion system receives promotion feedback from responding potential customers that have received the targeted promotion. Based upon the analysis of the responses, the system identifies common factors among the characteristics of the responding potential customers. In the subsequent step, as shown in 105, the system assesses the similarity between the characteristics of each one of the potential customers and the common factors. As shown in 106, the assessment is used to generate a new promotion list that comprises potential customers having a corresponding similarity level.

The new promotion list is sent to the listed potential customers during a targeted promotion, preferably, via different broadcasting servers. Preferably, during step 106, the targeted promotion system generates a new promotion list that comprises potential customers who are closely related to the responding customers.

As mentioned above, the system is a learning system. The new promotion list is used for generating a new targeted promotion. The responses to the new targeted promotion are analyzed to generate an additional new promotion list. As shown in 107, the cyclical process of generating a promotion on the basis of responses of a previous promotion can be repeated indefinitely. As described above, the new promotion list is generated according to quantitative factors. Such an empirical examination of the responses enables a relatively accurate estimation regarding which group of potential customers yields the best response rate. As described above, the targeted promotion is based upon information which has been gathered during previous promotions.

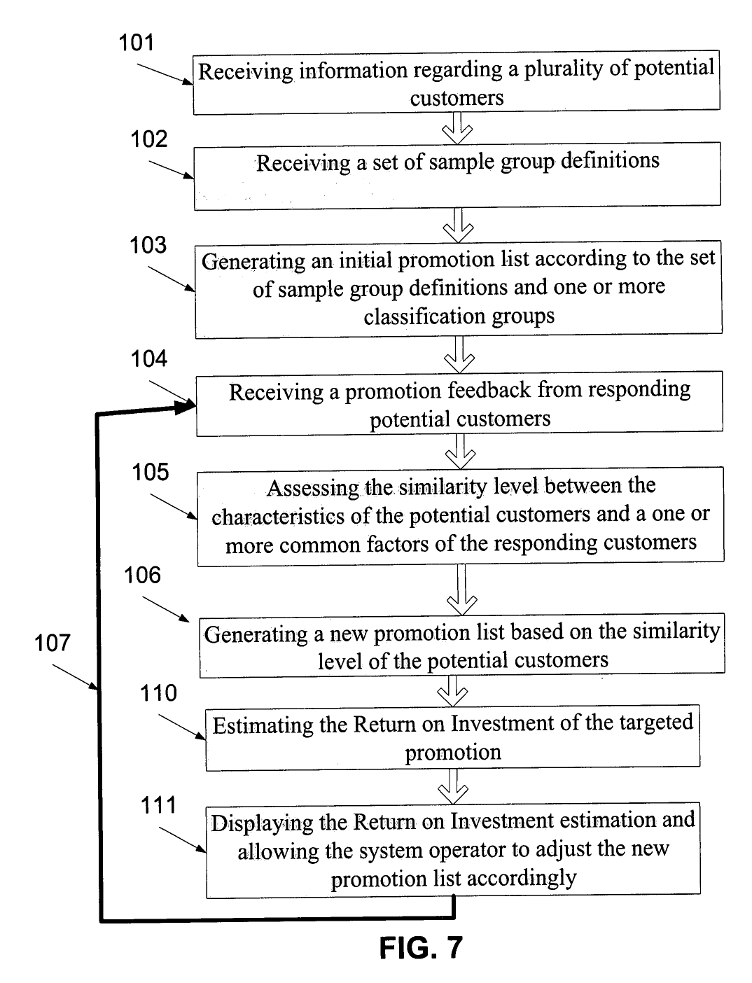

Reference is now made to FIG. 7 which shows another flowchart of an exemplary method according to a preferred embodiment. Steps 101-107 are similar to those shown in FIG. 6 above. However, FIG. 7 includes the further steps of estimating the return on investment 110 and facilitating the system operator to adjust the new promotion list 111.

As described above, one important factor in the decision making of marketers and advertisers is the return on investment and profitability factor. The return on investment factor estimates the chances to achieve the objectives of a targeted promotion in financial and other business objective terms.

Step 106 of generating a new promotion list is followed by a step 110 of estimating the return on investment of the targeted promotion which is done according to the new promotion list. As described above, the estimation may be based on various factors and functions that represent various business judgment and financial considerations. In the following step, 111, the targeted promotion system displays the return on investment estimation on a connected display device. The targeted promotion system further allows the system operator to adjust the new promotion list. The system operator receives a visual or a textual representation of the return on investment estimation. According to the display the system operator may adjust the new promotion list. In one preferred embodiment of the present invention the targeted promotion system scores each potential customer with grades which reflect the potential customer correspondence with different business objectives. The system operator may adjust the make-up of the new promotion list according to the given grades.

It is expected that during the life of this patent many relevant devices and systems will be developed and the scope of the terms herein, particularly of the terms network interactions, events, users, potential customer, promotions, computer networks, mobile phone, and servers, are intended to include all such new technologies a priori.

Additional objects, advantages, and novel features of the present invention will become apparent to one ordinarily skilled in the art upon examination of the foregoing examples, which are not intended to be limiting. Additionally, each of the various embodiments and aspects of the present invention as delineated hereinabove and as claimed in the claims section below finds experimental support in the foregoing examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A customer targeting tool for identifying and targeting potential customers of a customer base, comprising:
a discovery unit for empirically analyzing customer data regarding customer reaction to previous promotion activity, said analysis to identify groupings from customers differentiated by said reactions, and
a targeting unit, associated with said discovery unit, and configured to target customers belonging to groups discovered from customers showing correlated reactions.

2. The customer targeting tool of claim 1, wherein said analysis to identify groupings from customers is done according to at least one common characteristic of said customers.

3. The customer targeting tool of claim 2, wherein said targeting unit is adapted to be connected to a potential customer repository having a plurality of potential customer entries, each entry being associated with a potential customer; said customer targeting tool further comprising a classifier module for classifying said plurality of potential customer entries according to a set of classifying characteristics into a plurality of customer groups.

4. The customer targeting tool of claim 3, wherein said targeting unit is adapted to target potential customers of at least one of said groups, said targeted potential customers having at least one common characteristic with at least one of said groupings.

5. The customer targeting tool of claim 3, wherein said targeting tool is adapted to a sample group; wherein said sample group targeting tool is adapted to generate a promotion list according to said sample group.

6. The customer targeting tool of claim 4, wherein said targeting unit comprises an output unit, said output unit being adapted to output a promotion list for a targeted promotion, said promotion list comprising said targeted potential customers.

7. The customer targeting tool of claim 3, wherein said plurality of potential customer entries having a unified pattern.

8. The customer targeting tool of claim 3, wherein said plurality of potential customer entries comprises at least one customer data regarding the related potential customer response to previous promotion.

9. The customer targeting tool of claim 3, wherein said plurality of potential customer entries comprises at least one customer data regarding network interaction of a related potential customer.

10. The customer targeting tool of claim 9, wherein said customer data comprises information originated from at least one member of the group consisting of: roaming systems, billing systems, customer care systems, provisioning systems, service delivery platforms, intelligent network and prepaid systems, data warehouse systems, customer management systems, mediation platforms, Partner management systems, Common service platforms, Mobile Switching Center (MSC), Interactive Voice Response (IVR) systems, Home Location Register (HLR) systems, Wireless Access Point (WAP) gateways, WEB servers systems, content billing servers, SMS systems, MMS systems, voicemail systems, and Customer Relationship Management (CRM) systems.

11. The customer targeting tool of claim 9, wherein said network interaction comprise at least one member of the group consisting of: sending a Short Messaging Service (SMS) message, switching between different WEB pages, switching between different television channels, connecting to a specific Wireless network, reacting to an IVR, accessing an e-mail account, and using a Wireless Application Protocol (WAP) pull action, making an online purchase, placing an online order, and making an online payment for a product.

12. The customer targeting tool of claim 3, wherein said plurality of potential customer entries comprises additional potential customer information, said additional potential customer information consisting of at least one of the following group members: a potential customer average monthly telephone bill, a potential customer age, a potential customer gender, a potential customer address, a potential customer occupation, a potential customer average telecommunication service monthly bill, and a potential customer average telecommunication service usage time.

13. (canceled)

14. The customer targeting tool of claim 1, wherein said set of predetermined characteristics consists of at least one of following group members: behavioral patterns, content-interest preferences, and association with a particular demographic section.

15. The customer targeting tool of claim 1, further comprising a response input wherein said response input is operative for receiving promotion feedback from a plurality of potential customers responding to said targeted promotion.

16. The customer targeting tool of claim 15, wherein said response input is operative for receiving a list comprising said plurality of responding potential customers.

17. The customer targeting tool of claim 15, wherein said promotion feedback comprises information regarding the actual acceptance of said targeted promotion by said plurality of potential customers responding to said targeted promotion.

18. The customer targeting tool of claim 1, wherein said promotion list further comprises a plurality of estimated best promoting time records, each one of said estimated best promoting time records being associated with a corresponding potential customer in the list.

19. (canceled)

20. The customer targeting tool of claim 3, wherein each of said plurality of potential customer entries comprises a feedback vector, said feedback vector being adapted for storing the related potential customer response to previous targeted promotions.

21. The customer targeting tool of claim 20, wherein said classifier module further comprises a pattern recognition module operative for identifying behavioral patterns of said plurality of potential customer according to said feedback vectors; said targeting unit being adapted to target potential customers based upon said identification.

22.-23. (canceled)

24. The customer targeting tool of claim 6, further comprising a return on investment analyzer module, said return on investment analyzer module being operative for outputting a return on investment estimation of said promotion according to said promotion list.

25.-26. (canceled)

27. A method for targeting a promotion over one or more communication networks comprising:
a) receiving information regarding a plurality of potential customers having a set of characteristics;
b) receiving a sample group comprising a plurality of potential customers;
c) generating a promotion list based on said sample group;
d) receiving promotion feedback from a plurality of responding potential customers;
e) identifying at least one common factor among said plurality of responding potential customers; and
f) assessing the similarity between said set of characteristics of each one of said plurality of potential customers and said at least one common factor, using said assessment to generate a new promotion list.

28. The method of claim 26, further comprising repeating steps (d)-(f) a plurality of times.

29.-31. (canceled)

32. A system for targeting a response based promotion over at least one communication network comprising:
a plurality of customer records, each customer record comprising at least one promotion response entry being adapted for storing a related customer data, said related customer data comprises promotion response of a related potential customer to a targeted promotion;
a response input device for receiving said promotion responses from a plurality of responding customers; and
a clustering module adapted for identifying at least one common factor of said plurality of responding customers, said clustering module adapted for matching said at least one common factor with a subset of said related customer data of said plurality of customer records, said clustering module generating a new promotion list based upon said matching.

33. The system of claim 32, wherein said clustering module further comprises a response pattern module, said response pattern module being adapted to identify the response pattern of each of said plurality of customer records, said identification done by analyzing said at least one promotion response entry.

34. (canceled)

35. A customer targeting system for identifying and targeting potential customers of a customer base, comprising:
a customer database having a plurality of customers entries, each of said plurality of customers entries comprising at least one feature subentry;
a promotion response module for receiving a plurality of reactions of customers to promotion activities, said promotion response module being configured to store each one of said plurality of reactions in a respective feature subentry of a respective customer; and
a targeting unit, associated with said customer database, and configured to target potential customers of said plurality of potential customers entries having at least one common feature, said at least one common feature being chosen according to respective said at least one feature subentry.
